(19) United States
(12) Patent Application Publication
(10) Pub. No.: US 2026/0350947 A1
(43) Pub. Date: Nov. 5, 2026

(54) METHOD FOR PERFORMING ZERO-SHOT THREE-DIMENSIONAL-AWARE IMAGE EDITING VIA MULTIMODAL LARGE LANGUAGE MODEL-GUIDED MULTI-VIEW DIFFUSION, AND ASSOCIATED APPARATUS

(71) Applicant: MEDIATEK INC., Hsinchu City (TW)

(72) Inventors: Yu-Syuan Xu, Hsinchu City (TW); Hsien-Kai Kuo, Hsinchu (TW); Yi Yao, Taoyuan City (TW); Wen-Huang Cheng, New Taipei City (TW)

(73) Assignee: MEDIATEK INC., Hsinchu City (TW)

(21) Appl. No.: 19/390,694

(22) Filed: Nov. 17, 2025

Related U.S. Application Data
(60) Provisional application No. 63/799,803, filed on May 5, 2025.

(51) Int. Cl. G06T 19/20; G06T 5/60; G06T 5/77; G06T 7/11; G06T 15/20; G06T 15/50

(52) U.S. Cl. CPC G06T 19/20; G06T 5/60; G06T 5/77; G06T 7/11; G06T 15/20; G06T 15/503; G06T 2207/20081; G06T 2207/20084; G06T 2207/20212; G06T 2219/2004

(57) ABSTRACT

A method for performing zero-shot 3D-aware image editing via MLLM-guided processing such as MLLM-guided multi-view diffusion includes: utilizing a processing circuit to run a zero-shot 3D-aware image editing (Z3DE) framework to start performing 3D-aware image editing with a trained model of the Z3DE framework; and during performing the 3D-aware image editing, performing instruction-guided scene analysis based on at least one MLLM to transform a user instruction regarding a single input image into a refined version thereof and to automatically extract a target object mask for extracting a target object from the single input image, performing meta information fusion with the trained model according to the refined version of the user instruction to generate at least one novel view of the target object as a processed object of the target object, and performing 3D-aware object integration and scene synthesis with the processed object, in order to generate a corresponding output image.

### CROSS REFERENCE TO RELATED APPLICATIONS

This application claims the benefit of U.S. Provisional Application No. 63/799,803, filed on May 5, 2025. The content of the application is incorporated herein by reference.

### BACKGROUND

The present invention is related to image processing, and more particularly, to a method for performing zero-shot three-dimensional-aware (3D-aware) image editing via Multimodal Large Language Model (MLLM)-guided processing such as MLLM-guided multi-view diffusion, and to an associated apparatus.

According to the related art, in the realm of computer graphics and image processing, text-to-image generation using diffusion models has achieved substantial advancements, allowing for the synthesis of photorealistic images from textual descriptions. This technology has revolutionized the way users interact with image editing software, providing a more intuitive and natural language-based interface for image manipulation. Despite these advancements, extending these capabilities to 3D-aware editing of single red-green-blue (RGB) images introduces significant challenges, including inconsistent geometry, incomplete object details, and poor spatial coherence. Thus, a novel method and associated architecture are needed for solving the problems without introducing any side effect or in a way that is less likely to introduce a side effect.

### SUMMARY

It is an objective of the present invention to provide a method for performing zero-shot 3D-aware image editing via MLLM-guided processing such as MLLM-guided multi-view diffusion, and to provide an associated apparatus, in order to solve the above-mentioned problems.

At least one embodiment of the present invention provides a method for performing zero-shot 3D-aware image editing via MLLM-guided processing such as MLLM-guided multi-view diffusion, where the method can be applied to a processing circuit within an electronic device. For example, the method may comprise: utilizing the processing circuit to run a zero-shot 3D-aware image editing (Z3DE) framework to start performing 3D-aware image editing with a trained model of the Z3DE framework according to at least one input image, for generating at least one output image; and during performing the 3D-aware image editing with the trained model, performing instruction-guided scene analysis based on at least one MLLM to transform a user instruction regarding a single input image among the aforementioned at least one input image into a refined version of the user instruction and to automatically extract a target object mask for extracting a target object from the single input image, performing meta information fusion with the trained model according to the refined version of the user instruction to generate at least one novel view of the target object as a processed object of the target object, and performing 3D-aware object integration and scene synthesis with the processed object, in order to generate a corresponding output image among the aforementioned at least one output image.

At least one embodiment of the present invention provides an apparatus that operates according to the above method, where the apparatus may comprise at least the processing circuit within the electronic device. According to some embodiments, the apparatus may comprise the whole of the electronic device.

At least one embodiment of the present invention provides a computer-readable medium related to the above method, where the computer-readable medium may store a program code which causes the processing circuit to operate according to the method when executed by the processing circuit.

At least one embodiment of the present invention provides an apparatus for performing zero-shot 3D-aware image editing via MLLM-guided processing, where the apparatus may comprise a processing circuit that is arranged to control operations of an electronic device when installed within the electronic device. For example, the processing circuit is arranged to run a Z3DE framework to start performing 3D-aware image editing with a trained model of the Z3DE framework according to at least one input image, for generating at least one output image; and during performing the 3D-aware image editing with the trained model, the processing circuit performs instruction-guided scene analysis based on at least one MLLM to transform a user instruction regarding a single input image among the at least one input image into a refined version of the user instruction and to automatically extract a target object mask for extracting a target object from the single input image, performs meta information fusion with the trained model according to the refined version of the user instruction to generate at least one novel view of the target object as a processed object of the target object, and performs 3D-aware object integration and scene synthesis with the processed object, in order to generate a corresponding output image among the at least one output image.

It is an advantage of the present invention that, through proper design, the proposed method of the present invention, as well as the associated apparatus such as the processing circuit, can incorporate the semantic and reasoning capabilities of MLLMs to enable zero-shot 3D-aware editing. In addition, the proposed method and the associated apparatus such as the processing circuit can solve the related art problems without introducing any side effect or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a multi-stage inference control scheme of a method for performing zero-shot 3D-aware image editing via MLLM-guided processing such as MLLM-guided multi-view diffusion according to an embodiment of the present invention.

FIG. 2A is a diagram illustrating an instruction-guided scene analysis control scheme of the method according to an embodiment of the present invention.

FIG. 2B is a diagram illustrating a meta information fusion control scheme of the method according to an embodiment of the present invention.

FIG. 2C is a diagram illustrating a 3D-aware object integration and scene synthesis control scheme of the method according to an embodiment of the present invention.

FIG. 3 illustrates, in the sub-diagrams (a) and (b) thereof, some implementation details of the meta information fusion control scheme shown in FIG. 2B according to an embodiment of the present invention.

FIG. 4 is a diagram illustrating an electronic device involved with the method according to an embodiment of the present invention.

FIG. 5 is a flowchart of the method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

The proposed method can incorporate the semantic and reasoning capabilities of MLLMs to enable zero-shot 3D-aware editing. For better comprehension, text-to-image may refer to a generative artificial intelligence (AI) technology that creates images from text descriptions by combining AI models that understand language with those that create images, and diffusion models may refer to generative models that create images by starting with a random pattern and gradually shaping it into a clear picture. Diffusion models may work by destroying training data through the successive addition of Gaussian noise, then learning to recover the data by reversing this noising process. MLLMs may refer to advanced AI models that can process and generate content across multiple modalities, such as text, images, audio, and video. MLLMs may be designed to understand and integrate information from different types of data, enabling more comprehensive and versatile interactions and applications. For example, with the vanilla stable diffusion model, users can edit images using conditioning text prompts. However, applying stable diffusion techniques to 3D-aware editing of single RGB images presents significant technical challenges. In particular, when rotating an object within an image, details that are not visible from the original angle often appear incomplete or incorrect. In addition, translating an object within the space of the image can result in inconsistent geometry and a lack of spatial coherence, where the object does not seem to fit naturally within its new position. The present invention provides a novel architecture which can apply powerful MLLMs to interpret complex prompts, generate missing details, and reason about spatial layouts in a training-free framework to overcome the limitations of traditional 3D editing methods.

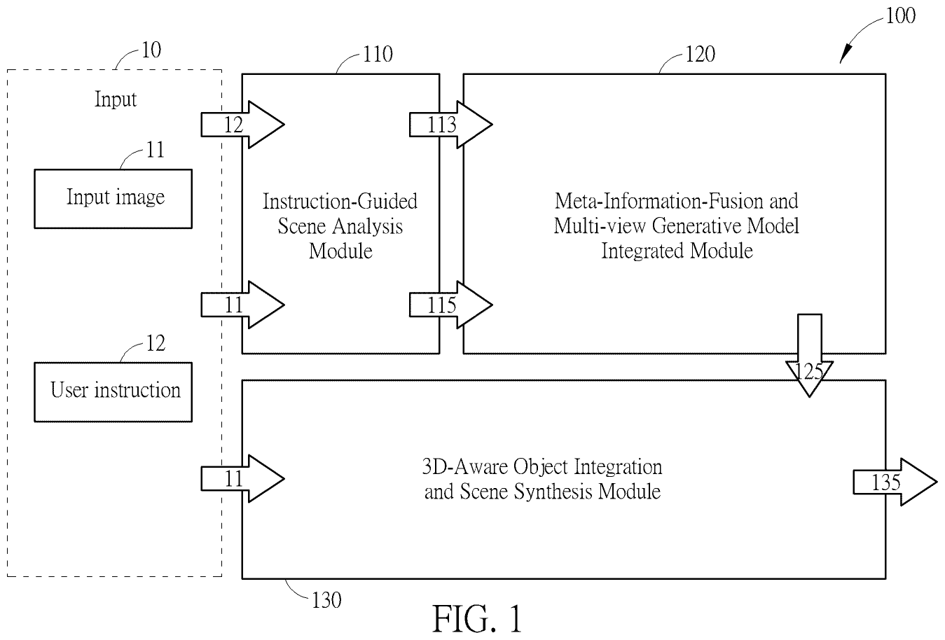

FIG. 1 is a diagram illustrating a hybrid control scheme of a method for performing zero-shot 3D-aware image editing via MLLM-guided processing such as MLLM-guided multi-view diffusion according to an embodiment of the present invention, where the method can be applied to a processing circuit within an electronic device. As shown in FIG. 1, a Z3DE framework 100 running on the processing circuit may comprise an instruction-guided scene analysis module 110, a meta-information-fusion and multi-view generative model integrated module 120 and a 3D-aware object integration and scene synthesis module 130. The processing circuit (or the Z3DE framework 100 running thereon) may be arranged to perform 3D-aware image editing with a trained model of the Z3DE framework 100 according to an input image 11 in order to generate an output image 135. For example, the associated operations of the Z3DE framework 100 may comprise:
(1) the Z3DE framework 100 (or the instruction-guided scene analysis module 110 therein) may perform instruction-guided scene analysis based on at least one MLLM (e.g., one or more MLLMs) to transform a user instruction 12 regarding the input image 11 into a refined version 113 of the user instruction 12 and to automatically extract a target object mask for extracting a target object 115 from the input image 11;
(2) the Z3DE framework 100 (or the meta-information-fusion and multi-view generative model integrated module 120 therein) may perform meta information fusion with the trained model according to the refined version 113 of the user instruction 12 to generate at least one novel view (e.g., one or more novel views) of the target object 115 as a processed object 125 of the target object 115; and
(3) the Z3DE framework 100 (or the 3D-aware object integration and scene synthesis module 130 therein) may perform 3D-aware object integration and scene synthesis with the processed object 125, in order to generate the output image 135;
where the Z3DE framework 100 may be arranged to receive multiple inputs 10 and to obtain the user instruction 12 from a user of the electronic device as an input among the multiple inputs 10 for being input into the Z3DE framework 100, and the user instruction 12 may indicate a request for editing the input image 11, but the present invention is not limited thereto. According to some embodiments, the architecture shown in FIG. 1 and/or the associated operations may vary. In addition, as the instruction-guided scene analysis module 110 in the Z3DE framework 100 is equipped with the aforementioned at least one MLLM for perform the instruction-guided scene analysis, the processing (e.g., the inference) of the instruction-guided scene analysis module 110 as well as the subsequent processing (e.g., the subsequent inference) of the Z3DE framework 100 (in particular, the meta-information-fusion and multi-view generative model integrated module 120 and the 3D-aware object integration and scene synthesis module 130 therein) can be regarded as belonging to the MLLM-guided processing mentioned above. For example, as the processing (e.g., the inference) of the meta-information-fusion and multi-view generative model integrated module 120 can be regarded as belonging to the MLLM-guided processing, and the meta-information-fusion and multi-view generative model integrated module 120 can be equipped with at least one multi-view generative model such as at least one multi-view diffusion model, the processing (e.g., the inference) of the meta-information-fusion and multi-view generative model integrated module 120 (in particular, the aforementioned at least one multi-view diffusion model therein) can be regarded as belonging to the MLLM-guided multi-view diffusion mentioned above.

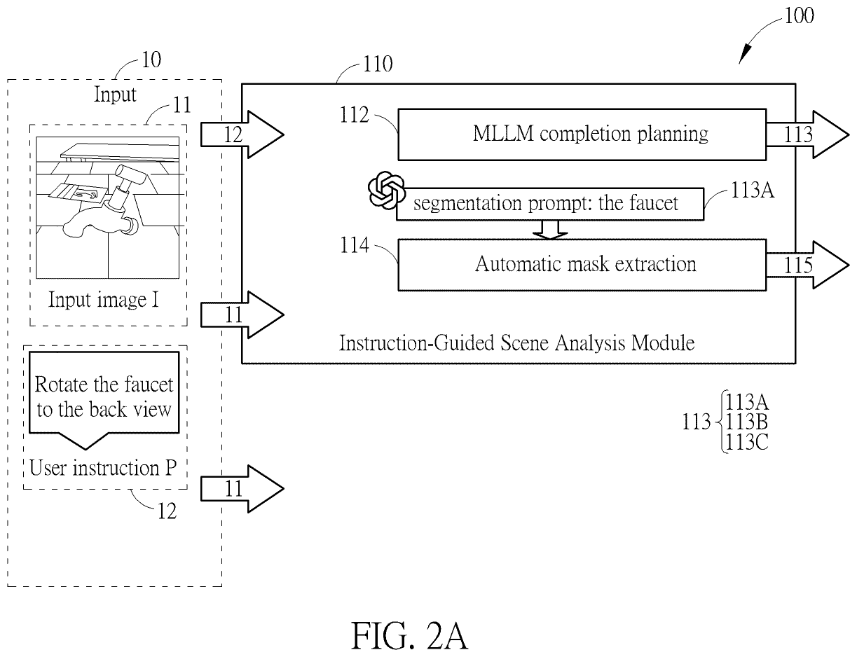

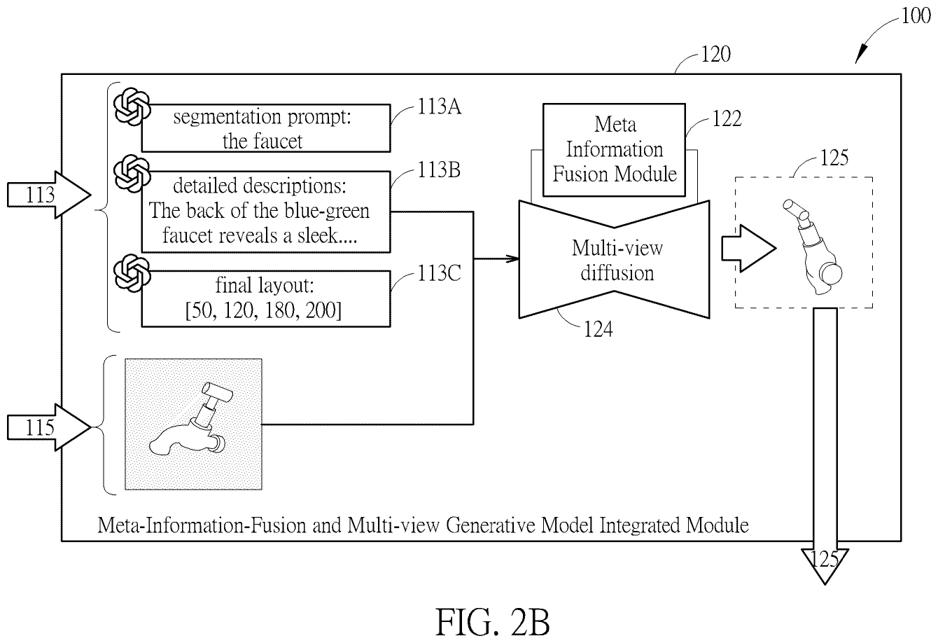

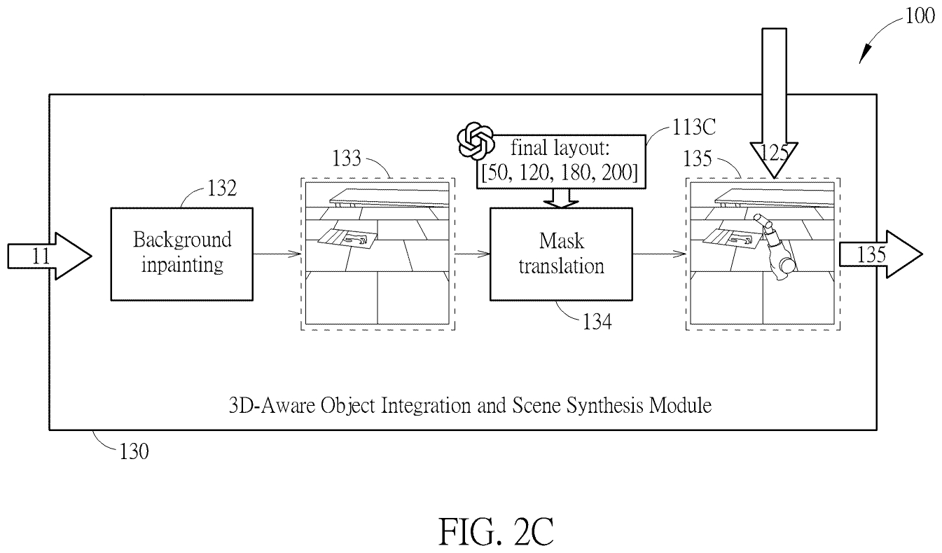

FIG. 2A is a diagram illustrating an instruction-guided scene analysis control scheme of the method according to an embodiment of the present invention. For example, the input image 11 can be implemented as the input image I having one or more objects such as a faucet, etc., and the user instruction 12 can be implemented as the user instruction P such as a prompt “Rotate the faucet to the back view” as shown in the lower left part of FIG. 2A. In addition, the instruction-guided scene analysis module 110 comprises multiple sub-modules such as an MLLM completion planning sub-module 112 and an automatic mask extraction sub-module 114 (respectively labeled “MLLM completion planning” and “Automatic mask extraction” for brevity), where the aforementioned at least one MLLM can be implemented within the MLLM completion planning sub-module 112, but the present invention is not limited thereto. According to some embodiments, the aforementioned at least one MLLM can be implemented as the MLLM completion planning sub-module 112.

During performing the instruction-guided scene analysis based on the aforementioned at least one MLLM to transform the user instruction 12 regarding the input image 11 into the refined version 113 of the user instruction 12 and to automatically extract the target object mask for extracting the target object 115 from the input image 11, the instruction-guided scene analysis module 110 can utilize the MLLM completion planning sub-module 112 therein to perform MLLM completion planning, and can utilize the automatic mask extraction sub-module 114 therein to perform automatic mask extraction. For example, the instruction-guided scene analysis module 110 (or the MLLM completion planning sub-module 112) can perform the MLLM completion planning to decompose the user instruction 12 such as the user instruction P into multiple components {113A, 113B, 113C} for acting as multiple prompts within the Z3DE framework 100. More particularly, during performing the MLLM completion planning to decompose the user instruction 12 into the multiple components {113A, 113B, 113C} for acting as the multiple prompts within the Z3DE framework 100, the MLLM completion planning sub-module 112 can perform the MLLM completion planning to decompose, through in-context learning and logical inference, the user instruction 12 such as the user instruction P into the multiple components {113A, 113B, 113C} for acting as the multiple prompts within the Z3DE framework 100. In addition, the instruction-guided scene analysis module 110 (or the automatic mask extraction sub-module 114) can perform the automatic mask extraction according to the component 113A to find the target object 115 in the input image 11 (e.g., the input image I) based on text description, to refine understanding of the target object 115, and to create a pixel-level mask as the target object mask, for extracting the target object 115 from the input image 11 with the target object mask.

As shown in FIG. 2A, the refined version 113 of the user instruction 12 may comprise the multiple components {113A, 113B, 113C}, and the multiple components {113A, 113B, 113C} may comprise the component 113A such as a segmentation prompt like a text string “the faucet” indicating that the target object 115 is the faucet (labeled “segmentation prompt: the faucet” for brevity), allowing the instruction-guided scene analysis module 110 (or the automatic mask extraction sub-module 114) to perform the automatic mask extraction according to the component 113A such as the segmentation prompt. As there may be more than one object in the input image 11, the instruction-guided scene analysis module 110 (or the automatic mask extraction sub-module 114) can find all objects in the input image 11 first, and more particularly, determine which objects are present and further perform the automatic mask extraction according to the component 113A such as the segmentation prompt to determine which object to deal with. As a result, the automatic mask extraction sub-module 114 can find the target object 115 in the input image 11 (e.g., the input image I) based on the text description of the segmentation prompt and refine the understanding of the target object 115 as the faucet among all objects in the input image 11, and create the pixel-level mask corresponding to the target object 115 as the target object mask, for extracting the target object 115 from the input image 11 with the target object mask.

According to some embodiments, given the component 113A such as the segmentation prompt, the automatic mask extraction sub-module 114 can perform the automatic mask extraction by using multiple vision-language models such as GroundingDINO, Contrastive Language-Image Pre-training (CLIP) and Segment Anything Model (SAM). For better comprehension, GroundingDINO may refer to an open-set object detection model that uses a language prompt to detect and output a bounding box for a specific object in an image, and excels at grounding language in a visual space; CLIP can align image and text representations into a shared embedding space, and can perform zero-shot image classification and image-text retrieval (e.g., finding the most relevant text for an image or vice-versa), but will be used for refining the understanding of the object in the architecture shown in FIG. 1 without providing a masking function; and SAM may refer to a promptable image segmentation model that can “cut out” any object in an image based on simple visual or coordinate-based prompts (like a bounding box or points), but it is class-agnostic and does not intrinsically know what the segmented object is. This is for illustrative purposes only, and is not meant to be a limitation of the present invention. According to some embodiments, the automatic mask extraction sub-module 114 can use GroundingDINO to find the target object 115 in the source image such as the input image 11 based on the text description, and then refine the understanding of the target object 115 with CLIP, and further use the Segment Anything Model (SAM) to create the pixel-level mask as the target object mask. For brevity, similar descriptions for these embodiments are not repeated in detail here.

FIG. 2B is a diagram illustrating a meta information fusion control scheme of the method according to an embodiment of the present invention. Among the multiple components {113A, 113B, 113C} mentioned above, the component 113B may comprise one or more detailed object descriptions, and the component 113C may comprise a final layout. As shown in FIG. 2B, the one or more detailed object descriptions can be implemented as one or more appearance-related text strings such as the text strings saying “The back of the blue-green faucet reveals a sleek . . . ” indicating that the target object 115 (or the faucet) is a blue-green faucet with the color of blue-green, and that the back of this blue-green faucet reveals a sleek appearance, and so on (labeled “detailed descriptions: The back of the blue-green faucet reveals a sleek . . . ” for brevity), and the final layout can be implemented as multiple layout parameters such as the parameters (x=50, y=120, w=180, h=200) (or “the parameters [x=50, y=120, w=180, h=200]” written in an array form) in which the parameters x, y, w, and h stand for the X-coordinate with respect to the X-axis, the Y-coordinate with respect to the Y-axis, the width measured along the X-axis, and the height measured along the Y-axis, respectively (labeled “final layout: [50, 120, 180, 200]” for brevity). This is for illustrative purposes only, and is not meant to be a limitation of the present invention. According to some embodiments, the multiple components {113A, 113B, 113C} can be written as the multiple components {113A, 113B, 113C, . . . } for indicating that there are more than three components {113A, 113B, 113C}. For example, the multiple components {113A, 113B, 113C, . . . } may further comprise another component such as a background prompt and yet another component such as one or more negative prompts.

During performing the meta information fusion with the trained model according to the refined version 113 of the user instruction 12 to generate the aforementioned at least one novel view of the target object 115 as the processed object 125 of the target object 115, the meta-information-fusion and multi-view generative model integrated module 120 can integrate visual embeddings with semantic cues from the aforementioned at least one MLLM within the MLLM completion planning sub-module 112 to enhance multi-view processing of a multi-view generative model within the trained model mentioned above for at least one unseen region (e.g., one or more unseen regions) of the target object 115. For example, the semantic cues from the aforementioned at least one MLLM within the MLLM completion planning sub-module 112 may represent the semantic cues indicated by the component 113B such as the one or more detailed object descriptions. As shown in FIG. 2B, the multi-view generative model may represent a multi-view diffusion model 124 (labeled “Multi-view diffusion” for brevity), and the multi-view processing may represent multi-view diffusion processing.

In addition, the aforementioned trained model may comprise a meta information fusion module 122 integrated into the multi-view generative model such as the multi-view diffusion model 124, for integrating the visual embeddings with the semantic cues. For better comprehension, assume that before the meta information fusion module 122 is integrated into the multi-view generative model such as the multi-view diffusion model 124, there are multiple channels such as 128 channels for inputting the visual embeddings in the multi-view diffusion model 124, but the present invention is not limited thereto. After the meta information fusion module 122 is integrated into the multi-view generative model such as the multi-view diffusion model 124, the original 128 channels can be split or divided into a first set of channels such as 64 channels for inputting the visual embeddings as well as a second set of channels such as 64 channels for inputting the text embeddings in the multi-view diffusion model 124. According to some embodiments, the channel count (or the number of channels) of the multiple channels for inputting the embeddings in the multi-view diffusion model 124 may vary, and the channel count of the first set of channels and the channel count of the second set of channels may vary correspondingly.

Taking the faucet in the input image I as an example of the target object 115 in the input image 11, in response to the user instruction 12 such as the user instruction P for requesting to rotate the faucet to the back view, the MLLM-guided multi-view diffusion such as the processing (e.g., the inference) of the meta-information-fusion and multi-view generative model integrated module 120 can make the faucet be rotated to the back view to act as the processed object 125, without introducing any problem among the related art problems (e.g., the details that are not visible from the original angle appear incomplete or incorrect, the inconsistent geometry and the lack of spatial coherence), and therefore the 3D-aware object integration and scene synthesis module 130 can perform the 3D-aware object integration and scene synthesis with the processed object 125 for generating the output image 135 to be an error-free image.

FIG. 2C is a diagram illustrating a 3D-aware object integration and scene synthesis control scheme of the method according to an embodiment of the present invention. The 3D-aware object integration and scene synthesis module 130 can perform the 3D-aware object integration and scene synthesis with the processed object 125 to insert the processed object 125 into a scene of the input image 11 according to a positional guidance from the aforementioned at least one MLLM within the MLLM completion planning sub-module 112, and to complete at least one missing region (e.g., one or more missing regions) using at least one inpainting model (e.g., one or more inpainting models). As shown in FIG. 2C, the 3D-aware object integration and scene synthesis module 130 comprises multiple sub-modules such as a background inpainting sub-module 132 and a mask translation sub-module 134 (respectively labeled “Background inpainting” and “Mask translation” for brevity). For example, the aforementioned at least one inpainting model can be implemented as an inpainting network.

During performing the 3D-aware object integration and scene synthesis with the processed object 125, the 3D-aware object integration and scene synthesis module 130 can utilize the background inpainting sub-module 132 therein to perform background inpainting, and can utilize the mask translation sub-module 134 therein to perform MLLM-guided object placement and final image synthesis. For example, the 3D-aware object integration and scene synthesis module 130 (or the background inpainting sub-module 132) can perform the background inpainting to remove the target object 115 from the input image 11 according to the extracted target object mask (i.e., the target object mask extracted by the automatic mask extraction sub-module 114), and to inpaint at least one missing area (e.g., one or more missing areas) with the inpainting network, for generating an inpainted background 133 corresponding to the input image 11 as the scene mentioned above, where the aforementioned at least one missing area comprises the aforementioned at least one missing region. In addition, the 3D-aware object integration and scene synthesis module 130 (or the mask translation sub-module 134) can perform the MLLM-guided object placement to obtain the component 113C, such as the final layout that is generated by the aforementioned at least one MLLM within the MLLM completion planning sub-module 112, as the positional guidance and to determine an MLLM-guided position and an MLLM-guided scale of the processed object 125 (e.g., the MLLM-guided position and the MLLM-guided scale with respect to the inpainted background 133) according to the final layout. When the final layout is implemented as the multiple layout parameters such as the parameters (x=50, y=120, w=180, h=200) for being input into the mask translation sub-module 134 as shown in FIG. 2C, the MLLM-guided position and the MLLM-guided scale can be implemented by way of the multiple layout parameters such as the parameters (x=50, y=120, w=180, h=200), but the present invention is not limited thereto. Additionally, the 3D-aware object integration and scene synthesis module 130 (or the mask translation sub-module 134) can perform the final image synthesis to composite the processed object 125 onto the inpainted background 133 at the MLLM-guided position. More particularly, during performing the final image synthesis to composite the processed object 125 onto the inpainted background 133 at the MLLM-guided position, the mask translation sub-module 134 can perform the final image synthesis to composite the processed object 125 onto the inpainted background 133 at the MLLM-guided position using alpha blending for multiple pixels along at least one border (e.g., one or more borders) of the processed object 125 and brightness adjustment of the multiple pixels.

According to some embodiments, the background inpainting sub-module 132 can perform the background inpainting to remove the target object 115 from the input image 11 according to the extracted target object mask, and to inpaint the aforementioned at least one missing area with the inpainting network such as LaMa, for generating the inpainted background 133 as the scene mentioned above, but the present invention is not limited thereto. For brevity, similar descriptions for these embodiments are not repeated in detail here.

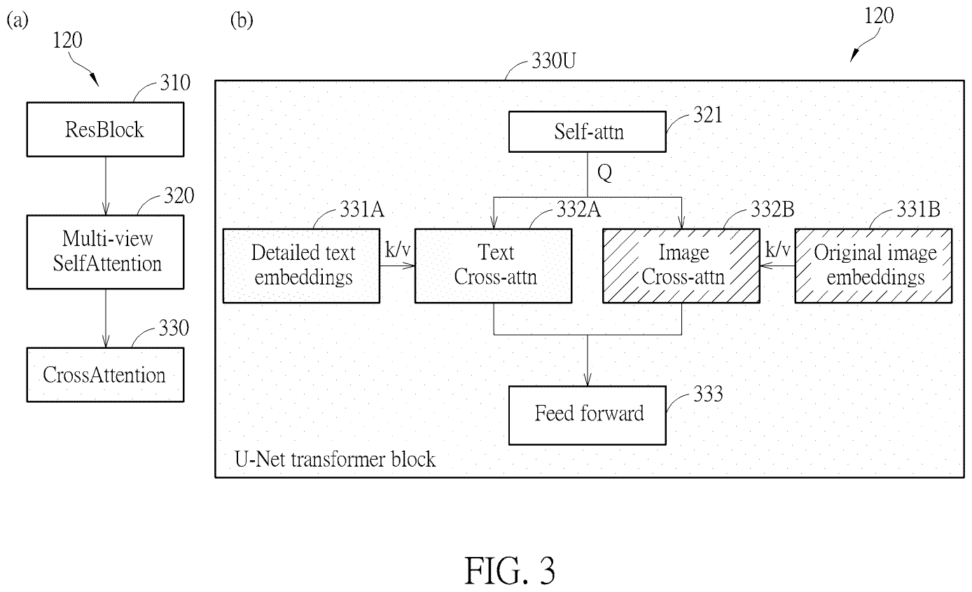

FIG. 3 illustrates, in the sub-diagrams (a) and (b) thereof, some implementation details of the meta information fusion control scheme shown in FIG. 2B according to an embodiment of the present invention. As shown in the sub-diagram (a), the trained model within the meta-information-fusion and multi-view generative model integrated module 120, such as the multi-view diffusion model 124 with the meta information fusion module 122 integrated therein, can be divided into multiple stages such as the Residual Blocks (Res-Block) stage 310, the Multi-view Self-Attention stage 320 and the Cross-Attention stage 330 (respectively labeled “ResBlock”, “Multi-view SelfAttention” and “CrossAttention” for brevity), but the present invention is not limited thereto. In addition, multiple U-Net transformer blocks {330U(j)|j=1, 2, . . . , J} of the multi-view diffusion model may have the same or similar architecture, where “J” may represent a positive integer that is greater than one, in particular, much greater than one, and “j” may represent an integer within the interval [1, J]. For example, any U-Net transformer block 330U(j) (or each U-Net transformer block 330U(j)) among the multiple U-Net transformer blocks {330U(j)|j=1, 2, . . . , J} may be referred to as the U-Net transformer block 330U. As shown in the sub-diagram (b), the U-Net transformer block 330U may comprise a Self-attention layer 321 (labeled “Self-attn” for brevity), two separate cross-attention layers such as the Text Cross-attention layer 332A and the Image Cross-attention layer 332B (respectively labeled “Text Cross-attn” and “Image Cross-attn” for brevity) that are coupled to the Detailed text embeddings 331A and the Original image embeddings 331B for receiving their key/value (k/v) respectively and are coupled to the Self-attention layer 321 for receiving its output Q, as well as a Feed forward layer 333 (labeled “Feed forward” for brevity). Among the two separate cross-attention layers mentioned above, one separate cross-attention layer such as the Image Cross-attention layer 332B can be configured for inputting visual embeddings (e.g., the Original image embeddings 331B) of the input image 11, and another separate cross-attention layer such as the Text Cross-attention layer 332A can be configured for inputting text embeddings (e.g., the Detailed text embeddings 331A) of the detailed object descriptions generated by the aforementioned at least one MLLM within the MLLM completion planning sub-module 112. For brevity, similar descriptions for this embodiment are not repeated in detail here.

TABLE 1

| | |
|---|---|
| Task | You are an expert in spatial reasoning and object transformations. Your task is |
| specification | to determine the new bounding box for an object based on a given |
| | transformation instruction, which may involve movement, scaling, rotation, |
| | or a combination of these operations. |
| Supporting | The input consists of a natural language instruction (e.g., “Move the [object] |
| details | 20 pixels to the right.” or “Scale up the [object] by 50%.”) and an initial |
| | bounding box in the format (x=?, y=?, w=?, h=?). For rotation, the bounding |
| | box remains unchanged. For movement along the depth axis (closer or |
| | farther), adjust w and h proportionally to simulate size changes. For |
| | horizontal movement (left/right), modify x, and for vertical movement |
| | (up/down), adjust y. If multiple transformations are described, apply them |
| | step by step |
| In-context | The expected output is a single-line response in the format: “New bounding |
| learning | box for [object]: (x=?, y=?, w=?, h=?)”, ensuring real-world spatial logic. |
| | Example 1 (Rotation): |
| | User prompt: “Rotate the apple from front view to side view.” Input Bounding |
| | Box: (x=120, y=100, w=170, h=90) Expected Output: “New bounding box |
| | for apple: (x=120, y=100, w=170, h=90)” (unchanged). |
| | Example 2 (Depth Movement): |
| | User prompt: “Move the banana closer to the camera.” Input Bounding Box: |
| | (x=90, y=90, w=50, h=50) Expected Output: “New bounding box for banana: |
| | (x=90, y=90, w=80, h=80)” (scaled up). |
| | Example 3 (Hybrid Transformation): |
| | User prompt: “Move the chair 30 pixels to the left and make it appear farther |
| | away.” Input Bounding Box: (x=200, y=150, w=100, h=120) Expected |
| | Output: “New bounding box for chair: (x=170, y=150, w=70, h=84)” (shifted |
| | left, scaled down). |

Table 1 illustrates a prompt instruction control scheme of the method according to an embodiment of the present invention. By applying in-context learning and logical inference to help the aforementioned at least one MLLM within the MLLM completion planning sub-module 112 to hypothesize the details, the proposed method can enhance the overall performance of the Z3DE framework 100.

In the architecture of the Z3DE framework 100 as shown in FIG. 1, FIG. 2A to FIG. 2C and FIG. 3, the proposed method combines at least the aforementioned at least one MLLM within the MLLM completion planning sub-module 112 with the trained model within the meta-information-fusion and multi-view generative model integrated module 120, such as the multi-view diffusion model 124 with the meta information fusion module 122 integrated therein, to enable zero-shot 3D-aware editing from the input image 10, which can be a single RGB image such as the input image I, addressing the lack of scalable solutions for real-world scenarios. In addition, the meta information fusion module 122 integrated into the multi-view diffusion model 124 can fuse the MLLM-generated semantic embeddings with the visual embeddings to synthesize the accurate and detailed novel views, particularly for occluded object regions like backsides. Additionally, the architecture of the Z3DE framework 100 is equipped with MLLM-driven spatial reasoning to guide precise object placement and scene synthesis, ensuring contextually consistent edits across tasks like rotation, translation, and object swapping.

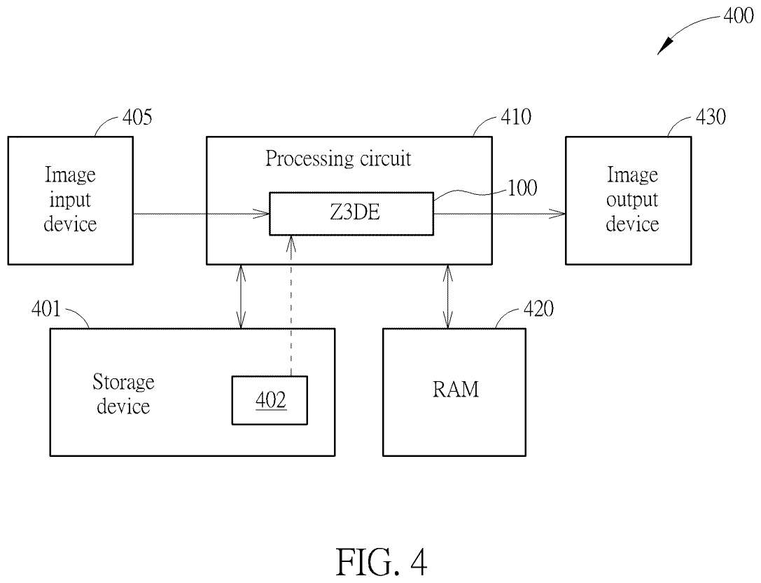

FIG. 4 is a diagram illustrating an electronic device 400 involved with the method according to an embodiment of the present invention. Examples of the electronic device 400 may include, but are not limited to: a personal computer (PC) such as a desktop computer and a laptop computer, a server, an all in one (AIO) computer, a tablet computer and a multifunctional mobile phone as well as a wearable device.

The electronic device 400 may comprise a processing circuit 410 that is capable of running the Z3DE framework 100 (labeled “Z3DE” for brevity), and may further comprise a computer-readable medium such as a storage device 401, an image input device 405, a random access memory (RAM) 420 and an image output device 430. The processing circuit 410 may be arranged to control operations of the electronic device 400. More particularly, the computer-readable medium such as the storage device 401 may be arranged to store a program code 402, for being loaded onto the processing circuit 410 to act as the Z3DE framework 100 running on the processing circuit 410. When executed by the processing circuit 410, the program code 402 may cause the processing circuit 410 to operate according to the method, in order to perform the associated operations of the Z3DE framework 100. For example, multiple program modules may run on the processing circuit 410 for controlling the operations of the electronic device 400, where the Z3DE framework 100 may be one of the multiple program modules, but the present invention is not limited thereto. In addition, the image input device 405 may be arranged to input or receive multiple input images, the RAM 420 may be arranged to temporarily store the multiple input images, the Z3DE framework 100 running on the processing circuit 410 may be arranged to process the multiple input images, and more particularly, perform image processing such as the 3D-aware image editing on the multiple input images to generate multiple output images, and the image output device 430 may be arranged to output or display the multiple output images, but the present invention is not limited thereto. For example, the RAM 420 may be arranged to temporarily store the multiple input images and the multiple output images, and/or the storage device 401 may be arranged to store the multiple input images and the multiple output images.

In the above embodiment, the storage device 401 can be implemented by way of a hard disk drive (HDD), a solid state drive (SSD) and a non-volatile memory such as a Flash memory, the image input device 405 can be implemented by way of a camera, the processing circuit 410 can be implemented by way of at least one processor, the RAM 420 can be implemented by way of a dynamic random access memory (DRAM), and the image output device 430 can be implemented by way of a display device such as a liquid-crystal display (LCD) panel, an organic light-emitting diode (OLED) panel, etc., where the display device can be implemented as a touch-sensitive panel, but the present invention is not limited thereto. According to some embodiments, the architecture of the electronic device 400 and/or the components therein may vary.

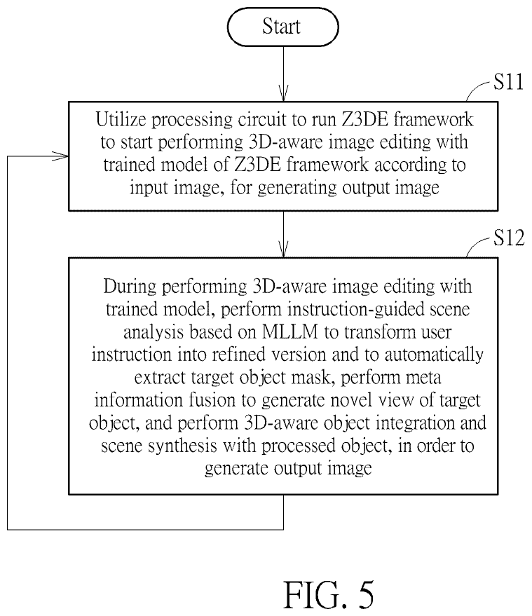

FIG. 5 is a flowchart of the method according to an embodiment of the present invention. The method can be applied to the electronic device 400 as well as the processing circuit 410 within the electronic device 400.

In Step S11, the electronic device 400 may utilize the processing circuit 410 to run the Z3DE framework 100 to start performing 3D-aware image editing with a trained model of the Z3DE framework according to at least one input image (e.g., an input image 11 such as that mentioned above), for generating at least one output image (e.g., an output image 135 such as that mentioned above).

In Step S12, during performing the 3D-aware image editing with the trained model, the processing circuit 410 (or the Z3DE framework 100 running thereon) may perform the instruction-guided scene analysis based on the aforementioned at least one MLLM to transform a user instruction regarding a single input image (e.g., the input image 11) among the at least one input image mentioned in Step S11, such as the user instruction 12 regarding the input image 11, into the refined version 113 of the user instruction 12 and to automatically extract the target object mask for extracting the target object 115 from the single input image such as the input image 11, perform the meta information fusion with the trained model according to the refined version 113 of the user instruction 12 to generate at least one novel view of the target object 115 as the processed object 125 of the target object 115, and perform the 3D-aware object integration and scene synthesis with the processed object 125, in order to generate a corresponding output image (e.g., the output image 135) among the at least one output image mentioned in Step S11.

In the working flow shown in FIG. 5, the loop comprising Steps S11 and S12 may be executed repeatedly, and there may be multiple iterations. For example, when a new iteration among the multiple iterations is entered, the single input image (e.g., the input image 11) and the user instruction regarding the single input image as mentioned in Step S12 may vary, and the associated processing (e.g., the associated inference) of the Z3DE framework 100, as well as the refined version 113 of the user instruction 12, the target object 115, the processed object 125, the corresponding output image (e.g., the output image 135), etc., may vary correspondingly. For brevity, similar descriptions for this embodiment are not repeated in detail here.

For better comprehension, the method may be illustrated with the working flow shown in FIG. 5, but the present invention is not limited thereto. According to some embodiments, one or more steps may be added, deleted, or changed in the working flow shown in FIG. 5. For example, after the associated processing of Steps S11 and S12 in a current iteration of the working flow shown in FIG. 5 is completed, when Step S11 is re-entered in another iteration, the processing circuit 410 may selectively change one or more parameters among the associated parameters (e.g., the model parameters) of the Z3DE framework 100 to reconfigure the Z3DE framework 100 (or the trained model thereof). For brevity, similar descriptions for these embodiments are not repeated in detail here.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing zero-shot three-dimensional-aware (3D-aware) image editing via Multimodal Large Language Model (MLLM)-guided processing, the method being applicable to a processing circuit within an electronic device, the method comprising:
utilizing the processing circuit to run a zero-shot 3D-aware image editing (Z3DE) framework to start performing 3D-aware image editing with a trained model of the Z3DE framework according to at least one input image, for generating at least one output image; and
during performing the 3D-aware image editing with the trained model, performing instruction-guided scene analysis based on at least one MLLM to transform a user instruction regarding a single input image among the at least one input image into a refined version of the user instruction and to automatically extract a target object mask for extracting a target object from the single input image, performing meta information fusion with the trained model according to the refined version of the user instruction to generate at least one novel view of the target object as a processed object of the target object, and performing 3D-aware object integration and scene synthesis with the processed object, in order to generate a corresponding output image among the at least one output image.

2. The method of claim 1, further comprising:
obtaining the user instruction from a user of the electronic device as an input for being input into the Z3DE framework, wherein the user instruction indicates a request for editing the single input image.

3. The method of claim 1, wherein performing the instruction-guided scene analysis based on the at least one MLLM to transform the user instruction regarding the single input image among the at least one input image into the refined version of the user instruction and to automatically extract the target object mask for extracting the target object from the single input image further comprises:
performing MLLM completion planning to decompose the user instruction into multiple components for acting as multiple prompts within the Z3DE framework, wherein the refined version of the user instruction comprises the multiple components, and the multiple components comprise a segmentation prompt; and
performing automatic mask extraction according to the segmentation prompt to find the target object in the single input image based on text description, to refine understanding of the target object, and to create a pixel-level mask as the target object mask, for extracting the target object from the single input image with the target object mask.

4. The method of claim 3, wherein the multiple components further comprise one or more detailed object descriptions and a final layout.

5. The method of claim 3, wherein performing the MLLM completion planning to decompose the user instruction into the multiple components for acting as the multiple prompts within the Z3DE framework further comprises:
performing the MLLM completion planning to decompose, through in-context learning and logical inference, the user instruction into the multiple components for acting as the multiple prompts within the Z3DE framework.

6. The method of claim 1, wherein performing the meta information fusion with the trained model according to the refined version of the user instruction to generate the at least one novel view of the target object as the processed object of the target object further comprises:
integrating visual embeddings with semantic cues from the at least one MLLM to enhance multi-view processing of a multi-view generative model within the trained model for at least one unseen region of the target object.

7. The method of claim 6, wherein the multi-view generative model represents a multi-view diffusion model, and the multi-view processing represents multi-view diffusion processing.

8. The method of claim 7, wherein each U-net transformer block among multiple U-net transformer blocks of the multi-view diffusion model comprises two separate cross-attention layers, wherein one separate cross-attention layer among the two separate cross-attention layers is configured for inputting visual embeddings of the single input image, and another separate cross-attention layer among the two separate cross-attention layers is configured for inputting text embeddings of detailed object descriptions generated by the at least one MLLM.

9. The method of claim 6, wherein the trained model comprises a meta information fusion module integrated into the multi-view generative model, for integrating the visual embeddings with the semantic cues.

10. The method of claim 1, wherein performing the 3D-aware object integration and scene synthesis with the processed object further comprises:
performing the 3D-aware object integration and scene synthesis to insert the processed object into a scene of the single input image according to a positional guidance from the at least one MLLM, and to complete at least one missing region using at least one inpainting model.

11. The method of claim 10, wherein the at least one inpainting model is implemented as an inpainting network; and performing the 3D-aware object integration and scene synthesis with the processed object further comprises:
performing background inpainting to remove the target object from the single input image according to the extracted target object mask, and to inpaint at least one missing area with the inpainting network, for generating an inpainted background corresponding to the single input image as the scene, wherein the at least one missing area comprises the at least one missing region.

12. The method of claim 11, wherein performing the 3D-aware object integration and scene synthesis with the processed object further comprises:
performing MLLM-guided object placement to obtain a final layout generated by the at least one MLLM as the positional guidance and to determine an MLLM-guided position and an MLLM-guided scale of the processed object according to the final layout; and
performing final image synthesis to composite the processed object onto the inpainted background at the MLLM-guided position.

13. The method of claim 12, wherein performing the final image synthesis to composite the processed object onto the inpainted background at the MLLM-guided position further comprises:
performing the final image synthesis to composite the processed object onto the inpainted background at the MLLM-guided position using alpha blending for multiple pixels along at least one border of the processed object and brightness adjustment of the multiple pixels.

14. The method of claim 10, wherein the at least one MLLM is arranged to determine the positional guidance based on the user instruction and 3D-aware reasoning.

15. An apparatus for performing zero-shot three-dimensional-aware (3D-aware) image editing via Multimodal Large Language Model (MLLM)-guided processing, the apparatus comprising:
a processing circuit, arranged to control operations of an electronic device when installed within the electronic device;
wherein:
the processing circuit is arranged to run a zero-shot 3D-aware image editing (Z3DE) framework to start performing 3D-aware image editing with a trained model of the Z3DE framework according to at least one input image, for generating at least one output image; and
during performing the 3D-aware image editing with the trained model, the processing circuit performs instruction-guided scene analysis based on at least one MLLM to transform a user instruction regarding a single input image among the at least one input image into a refined version of the user instruction and to automatically extract a target object mask for extracting a target object from the single input image, performs meta information fusion with the trained model according to the refined version of the user instruction to generate at least one novel view of the target object as a processed object of the target object, and performs 3D-aware object integration and scene synthesis with the processed object, in order to generate a corresponding output image among the at least one output image.

16. The apparatus of claim 15, wherein during performing the instruction-guided scene analysis based on the at least one MLLM to transform the user instruction regarding the single input image among the at least one input image into the refined version of the user instruction and to automatically extract the target object mask for extracting the target object from the single input image, the processing circuit performs MLLM completion planning to decompose the user instruction into multiple components for acting as multiple prompts within the Z3DE framework, and performs automatic mask extraction according to a segmentation prompt to find the target object in the single input image based on text description, to refine understanding of the target object, and to create a pixel-level mask as the target object mask, for extracting the target object from the single input image with the target object mask, wherein the refined version of the user instruction comprises the multiple components, and the multiple components comprise the segmentation prompt.

17. The apparatus of claim 15, wherein during performing the meta information fusion with the trained model according to the refined version of the user instruction to generate the at least one novel view of the target object as the processed object of the target object, the processing circuit integrates visual embeddings with semantic cues from the at least one MLLM to enhance multi-view processing of a multi-view generative model within the trained model for at least one unseen region of the target object.

18. The apparatus of claim 15, wherein during performing the 3D-aware object integration and scene synthesis with the processed object, the processing circuit performs the 3D-aware object integration and scene synthesis to insert the processed object into a scene of the single input image according to a positional guidance from the at least one MLLM, and to complete at least one missing region using at least one inpainting model.

19. The apparatus of claim 18, wherein the at least one inpainting model is implemented as an inpainting network; and during performing the 3D-aware object integration and scene synthesis with the processed object, the processing circuit performs background inpainting to remove the target object from the single input image according to the extracted target object mask, and to inpaint at least one missing area with the inpainting network, for generating an inpainted background corresponding to the single input image as the scene, wherein the at least one missing area comprises the at least one missing region.

20. The apparatus of claim 19, wherein during performing the 3D-aware object integration and scene synthesis with the processed object, the processing circuit performs MLLM-guided object placement to obtain a final layout generated by the at least one MLLM as the positional guidance and to determine an MLLM-guided position and an MLLM-guided scale of the processed object according to the final layout, and performs final image synthesis to composite the processed object onto the inpainted background at the MLLM-guided position.
